(19) United States
(12) Patent Application Publication
(10) Pub. No.: US 2013/0188292 A1
(43) Pub. Date: Jul. 25, 2013

(54) CERAMIC COMPOSITION AND A LAMINATED CERAMIC ELECTRONIC COMPONENT INCLUDING THE SAME THEREOF

(71) Applicants: KEISUKE KOBAYASHI, State College, PA (US); Clive A. Randall, State College, PA (US); Keiichi Hatano, Taito-ku (JP); Yutaka Doshida, Taito-ku (JP); Yoichi Mizuno, Taito-ku (JP); Minoru Ryu, Taito-ku (JP)

(72) Inventors: KEISUKE KOBAYASHI, State College, PA (US); Clive A. Randall, State College, PA (US); Keiichi Hatano, Taito-ku (JP); Yutaka Doshida, Taito-ku (JP); Yoichi Mizuno, Taito-ku (JP); Minoru Ryu, Taito-ku (JP)

(21) Appl. No.: 13/558,010

(22) Filed: Jul. 25, 2012

Related U.S. Application Data
(60) Provisional application No. 61/513,166, filed on Jul. 29, 2011.

(51) Int. Cl. H01G 4/30; C04B 35/495

(52) U.S. Cl. CPC H01G 4/30; C04B 35/495
USPC 361/301.4; 501/134; 264/620

(57) ABSTRACT

[Problems] To provide a ceramic composition that retains a high insulation resistance after being fired in a reductive atmosphere to form a laminated body.

[Means for Solving the Problem] A novel ceramic composition according to an embodiment of the invention include: (NaₓK₁₋ₓ)(Nb_{y}Ta_{1-y})O₃ (0≦x≦1.0, 0.3<y≦1.0) as main ingredient and Li and F in an amount ranging from 0.1 to 10.0 mol, calculated on lithium fluoride basis, relative to 100 mol of the main ingredient.

### FIELD OF THE INVENTION

The present disclosure relates to a substantially lead-free ceramic composition, in particular alkali metal-containing niobium oxide-type ceramic composition. The present disclosure also relates to a laminated ceramic electronic component comprising alkali metal-containing niobium oxide-type ceramic composition, and a method of manufacturing the ceramic composition.

### BACKGROUND

Various laminated ceramic electronic components, such as laminated piezoelectric actuators and laminated ceramic capacitors, are used in various applications. As is widely known, a laminated ceramic electronic component is comprised of a laminated body and external electrodes disposed on a side surface of the laminated body. The laminated body includes a plurality of ceramic sheets with printed internal electrodes. Such a laminated ceramic electronic component can be activated by DC voltage applied via the external electrodes. Preferable materials for the ceramic sheets are ceramic compositions having high permittivity and good piezoelectric characteristics. For example, lead zirconate titanate (Pb(Ti, Zr)O₃) is widely used. In recent years, a lead-free ceramic composition has been attracting attention as means to lower the environmental load. One example of such lead-free ceramic compositions is alkali metal-containing niobium oxide-type ceramic composition. For example, Japanese Patent Application No. 2000-313664 (Patent Literature 1) discloses an alkali metal-containing niobium oxide-type ceramic composition, indicated by a composition formula of K₁₋ₓNaₓNbO₃. An alkali metal-containing niobium oxide-type ceramic composition exhibits good piezoelectric properties and dielectric properties, depending on the composition ratio thereof.

A low-cost base metal such as nickel (Ni) or cupper (Cu) is used as a material of internal electrodes of a laminated ceramic electronic component. Japanese Patent Application No. 2008-239366 (Patent Literature 2) discloses a laminated ceramic capacitor made of a ceramic laminated body having internal electrodes of Ni fired in a reductive atmosphere. Since base metals tend to be oxidized at high temperatures, base metals used as materials of internal electrodes are ordinarily fired in a reductive atmosphere with the oxygen partial pressure of 1.0×10⁻⁴-1.0×10⁻¹⁴ atm.

### RELEVANT REFERENCES

### List of Relevant Patent Literature

Patent Literature 1: Japanese Patent Application Publication No. 2000-313664
Patent Literature 2: Japanese Patent Application Publication No. 2008-239366

### SUMMARY

### Problems to be Solved by the Invention

However, firing in a reductive atmosphere lowers the insulation resistance of a ceramic composition constituting a ceramic layer, degrading the performance of the laminated ceramic electronic component.

An embodiment of the invention provides a ceramic composition that retains a high insulation resistance after being fired in a reductive atmosphere. Further, an embodiment of the invention provides a laminated ceramic electronic component made of such a ceramic composition. Furthermore, an embodiment of the invention provides a method of manufacturing the ceramic composition and the laminated ceramic electronic component. Other purposes of the present invention will be understood based on the following detailed description and attached drawings.

### Means for Solving the Problem

A ceramic composition according to an embodiment of the present invention include: (NaₓK₁₋ₓ)(Nb_{y}Ta_{1-y})O₃ (0≦x≦1.0, 0.3<y≦1.0) as main ingredient and Li and F in an amount ranging from 0.1 to 10.0 mol, calculated on lithium fluoride basis, relative to 100 mol of the main ingredient.

### Advantages of the Invention

An embodiment of the invention provides a ceramic composition that retains a high insulation resistance after being fired in a reductive atmosphere. Further, an embodiment of the invention provides a laminated ceramic electronic component made of such a ceramic composition. Furthermore, an embodiment of the invention provides a method of manufacturing the ceramic composition and the laminated ceramic electronic component.

### BRIEF DESCRIPTION OF THE DRAWINGS

FIG. 1 shows a section view of a laminated ceramic electronic component according to an embodiment of the invention.

FIG. 2 shows a temperature dependency of the relative permittivity of a laminated ceramic electronic component according to an embodiment of the invention.

### DESCRIPTION OF EMBODIMENTS

A ceramic composition according to one embodiment may include an alkali metal-containing niobium oxide-type ceramic composition as main ingredient. The alkali metal-containing niobium oxide-type ceramic composition may be represented by the chemical formula of (NaₓK₁₋ₓ)(Nb_{y}Ta_{1-y})O₃. In an embodiment, LiF may be added in an amount ranging from 0.1 to 10.0 mol relative to 100 mol of the main ingredient. Such ceramic composition including Li and F in an amount ranging from 0.1 to 10.0 mol, calculated on lithium fluoride basis, relative to 100 mol of the main ingredient has higher insulation resistance compared with ceramic composition to which LiF is not added.

In one embodiment, ceramic composition may include Li and F in an amount ranging from 2.0 to 6.0 mol, calculated on lithium fluoride basis, relative to 100 mol of the main ingredient, thereby achieving the insulation resistance value leg equal to or more than 9.0 [log (Ω·cm)].

It is considered that the improvement in insulation resistance of the alkali metal-containing niobium oxide-type ceramic composition may be achieved for the following reasons: First, liquid phase may be formed in the composition during sintering process, and thereby a liquid phase sintering is materialized by adding LiF, which has a low melting point of 850° C., as accessory ingredients to the main ingredient represented by the chemical formula of (NaₓK₁₋ₓ)(Nb_{y}Ta_{1-y})O₃, wherein x and y satisfy the inequalities of 0≦x≦1.0 and 0.3<y≦1.0, respectively. Thus, the ceramic composition may be sintered to achieve higher densification compared with other ceramic composition obtained without adding LiF. In addition, if Na and/or K are volatilized during sintering of the molded body, the deficiencies of Na and/or K may be replaced with Li from LiF, thereby mitigating the deterioration of the insulation resistance. Additionally or alternatively, a part of Nb and/or Ta in the main ingredient may be replaced with Li from the added LiF. The Li replacing Nb and/or Ta may function as an acceptor, which may suppress generation of oxygen vacancies even under a reductive atmosphere. Furthermore, if oxygen vacancies are generated during sintering under a reduced atmosphere, F may compensate such oxygen vacancies and thereby mitigate generation of lattice defects.

It is generally known that the fewer the content ratio of Na and Ta in the chemical formula of (NaₓKₓ₋ₓ)(Nb_{y}Ta_{1-y})O₃, the larger the piezoelectric distortion constant (d33) of the ceramic composition (see, for example, K. H. Hellwege, O. Madelung Ed., and Landolt-Bornstein, “Numerical Data and Functional Relationships in Science and Technology”, Springer-Verlag, Volume 3 at page 288-291 (hereinafter referred to as “LB”). In particular, it is reported that very good piezoelectric characteristics may be achieved when x is 0.5 and y is 1.0, and the piezoelectric characteristics gradually deteriorates as the content ratio of Na increases in the range where x is equal to or more than 0.6. It is also reported that good piezoelectric properties may be achieved as the content ratio of K increases until X reaches 0 (see Japanese Journal Applied Physics of GA 48 0705 (2009)). In addition, research has been performed on a correlated relationship between content ratio of Ta/Nb and piezoelectric properties. For example, it is reported that high piezoelectric properties may be achieved in the range of 0.6≦y≦1.0 (See, Japanese Patent Application No. 2004-115293 and the American Journal and Ceramic Society Vol 88 No. 5 at page 1190-1196 (2005)). The piezoelectric properties are not substantially affected by the addition of LiF to the main ingredients within the above-mentioned range. Thus, in an embodiment, a compound comprised of a main ingredient represented by the formula of (NaₓK₁₋ₓ)(Nb_{y}Ta_{1-y}) including Li and F in the amount ranging from 0.1 to 10.0 mol, relative to 100 mol of the main ingredient, wherein 0≦x≦0.6 and 0.6≦y≦1, may be sintered under a reduced atmosphere with the oxygen partial pressure of 1.0×10⁻⁴-1.0×10⁻¹⁴ atm, to obtain a piezoelectric ceramic composition with a large d33 equal to or more than 90 pC/N and improved insulation resistance.

Similarly, it is known that the Curie temperature of the ceramic composition represented by the chemical formula of (NaₓK₁₋ₓ)(Nb_{y}Ta_{1-y})O₃ may be adjusted by adjusting the compositional ratio of Nb and Ta. For example, the Curie temperature may be adjusted to a near room temperature by adjusting the compositional ratio of the main ingredient to satisfy the inequalities of 0≦x≦1.0 and 0.3<y<0.6 in the above chemical formula (See, LB). This adjustable nature of the Curie temperature is not substantially affected by the addition of LiF to the main ingredient within the above-mentioned range. Accordingly, in one embodiment, a dielectric utilizing a high relative permittivity at the Curie temperature may be produced by adjusting the chemical composition of the main ingredient to satisfy the inequalities of 0≦x≦1.0, 0.3<y<0.6.

Similarly, it is known that, in the ceramic composition represented by the chemical formula of (NaₓK₁₋ₓ)(Nb_{y}Ta_{1-y})O₃, the fewer the content ratio of K and/or Ta becomes, the more likely the ceramic composition may be successfully sintered and the more likely lower dielectric loss may be achieved. In one embodiment, the ceramic composition may be sintered successfully and may achieve a lowered dielectric loss (tan δ) by adjusting the chemical composition of the main ingredient so as to satisfy the inequalities of 0.6<x≦1.0 and 0.6≦x≦1.0 in the above chemical formula.

Various piezoelectric ceramic electronic components may be produced by using the above-described ceramic compositions. The ceramic compositions having good piezoelectric characteristics may be suitable to produce piezoelectric laminated ceramic electronic components. The ceramic composition having the main ingredient indicated by the chemical formula of (NaₓK₁₋ₓ)(Nb_{y}Ta_{1-y})O₃, wherein 0≦x≦0.6 and 0.6≦y≦1.0, may have good piezoelectric characteristics and may be suitable for piezoelectric laminated ceramic electronic components. Piezoelectric laminated ceramic electronic components according to various embodiments include, but are not limited to, piezoelectric actuators, piezoelectric speakers, piezoelectric microphones, piezoelectric vibrators, piezoelectric generators, ultrasonic motors, acceleration sensors, and piezoelectric filters.

If the ceramic composition according to one embodiment has good relative permittivity, it may be suitable to be used for dielectric laminated ceramic electronic components. The ceramic composition according to an embodiment having the main ingredient represented by (NaₓK₁₋ₓ)(Nb_{y}Ta_{1-y})O₃, wherein 0≦x≦1.0 and 0.3<y<0.6, may have good piezoelectric characteristics and may be suitable for dielectric laminated ceramic electronic components. Although the dielectric laminated ceramic electronic components include a laminated ceramic capacitor, this arrangement is not limitative.

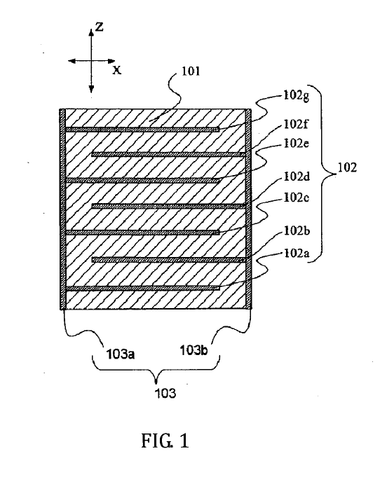

FIG. 1 is a section view of a laminated ceramic electronic component according to an embodiment of the invention. As shown, a laminated ceramic electronic component according to an embodiment comprises: a laminated body formed by laminating a plurality of layers 101 and internal electrodes 102a-102g alternatively; and external electrodes 103a and 103b formed on the outer surface (side) of the laminated body. The internal electrodes 102a-102g are mainly formed of base metals such as Cu or Ni. The internal electrodes 102a-102g may include precious metals such as Pd, Pt, or Au in addition to the base metals. The external electrode 103a is electrically connected to each of the internal electrodes 102a, 102c, 102e, and 102g. The external electrode 103b is electrically connected to each of the internal electrodes 102b, 102d, and 102f. The configured and assembled body is sintered and then polarized to obtain a laminated ceramic electronic component. If the ceramic layer 101 has piezoelectric characteristics, the laminated ceramic electronic component may be displaced in the direction of Z-axis of the FIG. 1 upon application of voltage between the external electrodes 103a and 103b. Thus, the laminated ceramic electronic component may function as a piezoelectric actuator, for example. If the ceramic layer 101 has high relative permittivity, the laminated ceramic electronic component shown in FIG. 1 may be used as a laminated ceramic capacitor.

One example of a manufacturing method for obtaining a piezoelectric laminated ceramic electronic component of FIG. 1 will be explained. First, as raw materials, an alkali metal-containing niobium oxide-type ceramic composition which is for the main ingredient of the ceramic layer 101, sodium compound such as sodium carbonate (Na₂CO₃) or sodium bicarbonate (NaHCO₃), potassium compounds such as carbonate (K₂CO₃) or potassium hydrogen carbonate (KHCO₃), niobium compounds such as niobium pentoxide (Nb₂O₅), and tantalum compounds such as 5 tantalum oxide (Ta₂O₅) are prepared.

Next, the raw materials of the main ingredient are accurately weighed. More particularly, each of the raw materials is weighed so that the composition of the main ingredient represented by the chemical formula of (NaₓK_{1-X})(Nb_{y}Ta_{1-y})O₃ can be within the range described herein. The weighed raw materials are put into a ball mill equipped with partially stabilized Zirconia (PSZ) balls. The starting materials are wet-mixed in an organic solvent, such as ethanol, for the period of 10 to 60 hours, and then dried by volatilization to obtain a mixed material. The thus-obtained mixed material is then pre-sintered at the temperature of 700 to 950 for 1 to 10 hours, thereby obtaining a pre-sintered composition. The pre-sintered composition is then cracked by a ball mill to obtain pre-sintered powders. Next, a certain amount of lithium fluoride (LiF) powder is added to the pre-sintered powders, and the pre-sintered powders are wet-mixed using a ball mill equipped with PSZ balls in an organic solvent, such as ethanol, for the period of 10 to 60 hours, and then dried by volatilization, thereby obtaining a pre-sintered powder mixture. The thus-obtained pre-sintered powder mixture is added by an organic binder and dispersant and then wet-mixed by using a ball mill in an organic solvent, such as water or ethanol, to obtain a ceramic slurry. The thus-obtained ceramic slurry is fabricated using a doctor blade or other suitable methods to obtain ceramic green sheets.

Next, conductive layer patterns which function as internal electrodes are screen printed on each of the ceramic green sheets by using a conductive paste made of base metals, such as Ni or Cu, as the main ingredient. Next, the ceramic green sheets with the conductive layer patterns are laminated alternatively to form a laminated body. A pair of ceramic green sheets without conductive layer patters are press-attached to the upper and lower surfaces of the laminated body to obtain a ceramic laminated body where conductive patterns and ceramic green sheets are alternatively laminated.

Next, the thus-obtained ceramic laminated body is received in, for example, an alumina-made sheath where a debinder process is performed at the temperature of 300-500° C. Then, the ceramic laminated body is sintered at the temperature ranging from 800-1400° C. under a reduced atmosphere having the oxygen partial pressure of 1.0×10⁻⁴-1.0×10⁻¹⁴ atm. Thus, a ceramic sintered body may be obtained. It may be preferable that the sintering is performed at 950-1200° C. under a reduced atmosphere having the oxygen partial pressure of 1.0×10⁻⁴-1.0×10⁻¹⁰. The firing temperature may depend on chemical physical property of electrodes (e.g., melting point).

Next, a conductive paste made mainly of Ag, Cu, or Ni is printed on both of the exposed edges of the inner electrodes at the temperature of 750-850° C. to form a pair of external electrodes on the outer surface of the laminated body. The external electrodes may be formed by various methods such as sputtering or vacuum deposition. Thus, a laminated ceramic electronic component as shown in FIG. 1 may be obtained. A voltage may be applied between the pair of external electrodes for polarization, thereby obtaining laminated piezoelectric ceramic electronic components.

A laminated ceramic electronic components thus fabricated retain a high insulation resistance after being fired in a reductive atmosphere. These laminated ceramic electronic components, having excellent piezoelectric characteristics and/or relative permittivity, can be used, as required, as laminated piezoelectric ceramic electronic components of a piezoelectric actuator and laminated capacitors. However, the applications of a ceramic composition according to an embodiment of the invention are not limited to these applications. The ceramic composition can be used for various applications where high insulation resistance is required after firing in a reductive atmosphere.

### EXAMPLES

Various examples according to various embodiments of the present invention will be described below. It should be appreciated that such examples are provided solely to illustrate various structure, composition and other aspects of the present invention, and should not be regarded as limiting.

### Example 1

In the Example 1, when the main ingredient satisfies equations of x=0.5 and y=1.0 in a chemical formula of (NaₓK₁₋ₓ)(Nb_{y}Ta_{1-y})O₃ (i.e., the main ingredient is expressed by a chemical formula of Na_{0.5}K_{0.5}Nb_{0.5}O₃), a plurality of Samples having different amounts of lithium fluoride (LiF) were produced to determine an addition amount relative to a main ingredient.

Each of K₂CO₃, Na₂CO₃, Nb₂O₅, and Ta₂O₅ were prepared as starting materials of Na_{0.5}K_{0.5}Nb_{0.5}O₃, and fully dried at the temperature of around 200° C., respectively. Next, each of the dried starting materials was weighed so that the composition thereof is Na_{0.5}K_{0.5}Nb_{0.5}O₃ (that is, x=0.5 and y=1.0). Next, The weighed starting materials were wet-mixed in an ethanol solvent for the period of 24 hours using a ball mill. Then, the thus obtained mixture was pre-sintered at the temperature of 900° C. for the period of 3 hours to obtain a pre-sintered composition. The calcined substance was disintegrated using a ball mill to obtain calcined powder. A lithium fluoride (LiF) in each of the amounts as indicted in Table 1, relative to 100 mol thereof was added to thus-obtained pre-sintered composition. Then, the mixture was dried, thereby obtaining six varieties of ceramic powders having different amounts of LiF.

Then, the six varieties of ceramic powders were fabricated in disc-shape by using a press machine, thereby obtaining disc-shaped pressurized powder bodies having diameter of about 10 mm and thickness of about 0.5 mm. Next, a conductive paste containing Ni as main ingredient was applied on surfaces of each of the pressurized powder bodies. Then, each of the conductive paste applied pressurized powder bodies was fired at the temperatures of 950-1200° C. under a reduced atmosphere having oxygen partial pressure of 1.0×10⁻⁴-1.0×10⁻¹⁴ atm for the period of two hours, thereby obtaining disc-shaped sintered body. A pair of platinum electrodes was formed on the both sides of thus-obtained disc-shaped sintered body by a sputtering technique. The platinum electrodes were fabricated so that the electrodes were electrically connected to the conductive paste disposed on the surface of the sintered body.

For each of the six varieties of Samples (as indicated Sample 1 through 6 in Table 1), DC voltage-current characteristics of external electrodes were measured by pico ampere meter (product name “4140B”, manufactured by Hewlett-Packard). Based on the measurements, logarithmic log (Ω·cm) of each insulation resistance at a room temperature (25° C.) was calculated. Relative permittivity (∈s) and dielectric loss (tan δ) of a signal frequency of 1 kHz at a room temperature were also calculated by using a LCR meter (product name “4284 A”, manufactured by Agilent Model). In addition, each of the Samples were polarized in a silicone oil bath at the temperature of 150° C. by applying a 3 kV/mm electric field for the period of 15 minutes. To avoid impact of characteristics variation, each of thus polarized Samples were left for the period equal to or more than 48 hours. Then, piezoelectric characteristics d₃₃ in the direction of 33 (pC/N) of each of the polarized Samples were measured by a d₃₃ meter (product name “ZJ 2”, manufactured by Academia Sinica). Table 1 indicates the measurement results. Asterisk “*” was put before the number of Samples 1 and 6 in Table 1 to clarify that the Sample 1 and 6 were out the range of the invention.

TABLE 1

| Sample | | | Amount of | | tanδ | | log |
|---|---|---|---|---|---|---|---|
| No. | x | y | LiF (mol) | εₛ | (%) | d₃₃ (pC/N) | (Ω · cm) |
| 1 | 0.5 | 1.0 | 0.0 | 450 | 37% | non | 5.2 |
| | | | | | | polarizable | |
| 2 | 0.5 | 1.0 | 0.1 | 390 | 7.8% | 40 | 7.5 |
| 3 | 0.5 | 1.0 | 3.0 | 380 | 5.0% | 99 | 9.4 |
| 4 | 0.5 | 1.0 | 5.0 | 460 | 3.3% | 138 | 10.9 |
| 5 | 0.5 | 1.0 | 10.0 | 400 | 5.5% | 85 | 9.1 |

| | | | | |
|---|---|---|---|---|
| 6 | 0.5 | 1.0 | 15.0 | non sinterable |

As indicated in Table 1, the Sample 1, without an addition of LiF, had a large dielectric loss of 37% and low logarithm of insulation resistance log (Ω·cm) of 5.2. In addition, a breakdown occurred to the Sample in an electric field equal to or lower than 3 kV/mm; therefore, it could not be polarized. As such, chemical composition without an addition of LiF, indicated by a chemical formula of Na_{0.5}K_{0.5}NbO₃, had a poor capability as a capacitor due to a large dielectric loss, nor could it be utilized as a piezoelectric ceramic electronic component due to a breakdown occurring during a polarization process.

The Sample 2 was a Sample including 0.1 mol of LiF, relative to 100 mol of the main ingredient, indicated by a chemical formula of Na_{0.5}K_{0.5}Nb_{0.5}O₃. A ceramic composition of the Sample 2 included Li and F as LiF in an amount of 0.1 mol, relative to 100 mol of the main ingredient, indicated by a chemical formula of Na_{0.5}K_{0.5}Nb_{0.5}O₃. As indicated by Table 1, the Sample 2 had a logarithm of insulation resistance log (Ω·cm) of 7.2 and was confirmed having a relatively high insulation resistance compared with the Sample 1. In addition, a d₃₃ of the Sample 2 was 40 pC/N and was confirmed that the Sample 2 had piezoelectric characteristics.

The Sample 3 through 5 were the Sample including 3.0 mol, 5.0 mol, and 10.0 mol of LiF, respectively, relative to 100 mol of the main ingredient indicated by a chemical formula of Na_{0.5}K_{0.5}Nb_{0.5}O₃. Each of the Samples 3 through 5 had a logarithm of insulation resistance log (Ω·cm) equal to or higher than 9.0 and was confirmed as having a relatively high insulation resistance compared with the Sample 1 without an addition of LiF. d₃₃ of the Samples 3 through 5 were 99 pC/N, 138 pC/N, and 85 pC/N, respectively, and was confirmed for each as having good piezoelectric characteristics. In particular, d₃₃ of the Sample 4 is 138 pC/N, and was confirmed as having piezoelectric characteristics equivalent to piezoelectric ceramic electronic components including PZT as main ingredient.

The Sample 6 was Sample including 15.0 mol of LiF, relative to 100 mol of the main ingredient, indicated by a chemical formula of Na_{0.5}K_{0.5}Nb_{0.5}O₃. The Sample 6 was not densely sintered; therefore, it could not be utilized as a ceramic electronic component.

From the results, it was confirmed that when LiF was added in an amount ranging from 0.1 mol to 10.0 mol to a Na_{0.5}K_{0.5}Nb_{0.5}O₃ composition (i.e., adding Li and F in an amount ranging from 0.1 to 10.0 mol, calculated on lithium fluoride basis, relative to 100 mol of the main ingredient of Na_{0.5}K_{0.5}Nb_{0.5}O₃), better insulation resistances than the Samples without addition of LiF were obtained. An improved insulation resistance was materialized wherein lost Na and/or K in the main ingredient were replaced with Li; the Li having replacing a part of Nb and/or Ta functioned as an acceptor; and F supplemented an oxygen deficit. Accordingly, insulation resistances were improved not only when the main ingredient satisfied equations of x=0.5 and y=1.0, but also when inequalities of 0≦x≦1.0 and 0.3<y≦1.0 were satisfied.

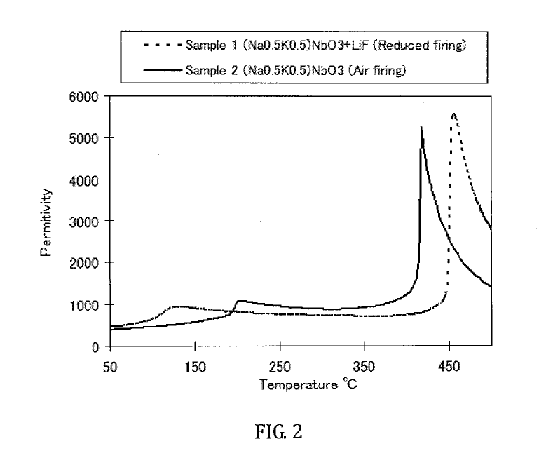

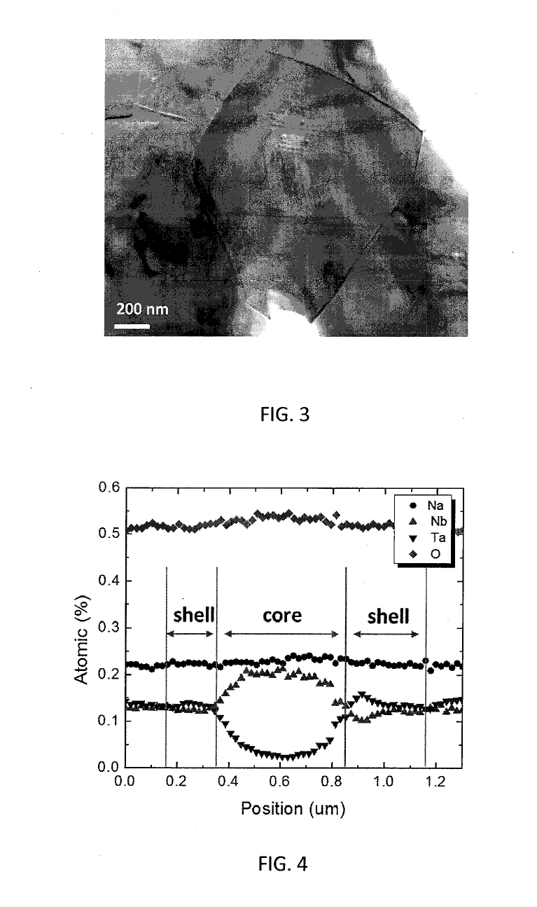

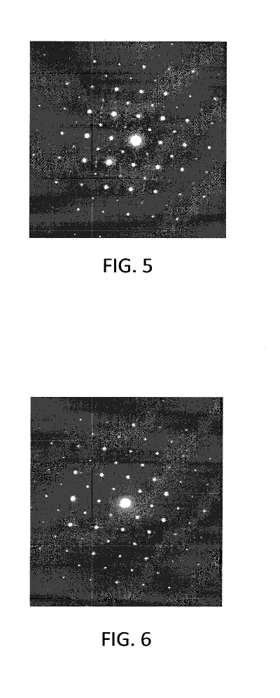

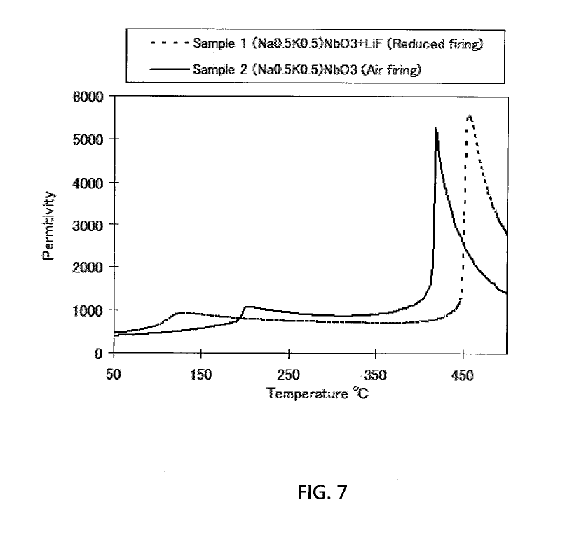

In addition, the temperature dependability of relative permittivity of Sample 4 was measured by a LCR meter. The measuring frequency was set to 1 kHz. FIG. 2 indicates measurement results of the temperature dependency of relative permittivity of the Sample 4. FIG. 2 also indicates measurement results of the temperature dependency of relative permittivity of Na_{0.5}K_{0.5}Nb_{0.5}O₃ composition without an addition of LiF fired under the atmosphere. Sample 1 of FIG. 2 shows a graph indicating the temperature dependency of relative permittivity of the Sample 4. Sample 2 of FIG. 2 shows a graph indicating the temperature dependency of relative permittivity of Na_{0.5}K_{0.5}Nb_{0.5}O₃ composition without an addition of LiF fired under the atmosphere. As indicated by FIG. 2, the Sample 4 has a high Curie temperature and desirable characteristics as a piezoelectric ceramic composition compared with the Na_{0.5}K_{0.5}Nb_{0.5}O₃ composition without an addition of LiF fired under the atmosphere. As such, it was confirmed that a ceramic composition including 5.0 mol of LiF, relative to 100 mol of Na_{0.5}K_{0.5}Nb_{0.5}O₃ as the main ingredient, had especially good characteristics as a piezoelectric ceramic composition.

### Example 2

In the Example 2, Samples were produced by adding 5.0 mol of LiF, relative to 100 mol of a main ingredient, indicated by a chemical formula of NaₓK₁₋ₓNb_{y}Ta_{1-y}O₃, and then each of the Samples were evaluated. Table 2 indicates component composition of the prepared Samples (Sample 7 through 16). To clarify that the Samples 7 and 8 are out the range of the invention, “*”was put on the number of each Sample in Table 2.

TABLE 2

| Sample No. | x | y | Amount of LiF (mol) |
|---|---|---|---|
| 7 | 0.0 | 0.2 | 5.0 |
| 8 | 0.0 | 0.3 | 5.0 |
| 9 | 0.0 | 0.5 | 5.0 |
| 10 | 0.0 | 0.7 | 5.0 |
| 11 | 0.0 | 1.0 | 5.0 |
| 12 | 0.5 | 0.6 | 5.0 |
| 13 | 0.5 | 0.7 | 5.0 |
| 14 | 0.5 | 0.8 | 5.0 |
| 15 | 0.5 | 0.9 | 5.0 |
| 16 | 1.0 | 1.0 | 5.0 |

The Samples 7 through 16 having respective chemical composition as indicated by Table 2 were produced by the same method of the embodiment. For each of the Samples 7 through 16, relative permittivity (∈s) dielectric loss (tan δ), logarithmic log (Ω·cm) of insulation resistance, and piezoelectric characteristic characteristics in the direction of 33 (d33) were evaluated. Table 3 (3?) shows evaluation results of each of the Samples.

TABLE 3

| Sample No. | εₛ | tanδ (%) | d₃₃ (pC/N) | log (Ω · cm) |
|---|---|---|---|---|
| 7 | 620 | 7.2 | — | 10.0 |
| 8 | 890 | 6.5 | — | 10.5 |
| 9 | 1560 | 5.6 | — | 10.2 |
| 10 | 380 | 4.5 | 83 | 10.6 |
| 11 | 330 | 2.9 | 91 | 10.1 |
| 12 | 1500 | 4.4 | 54 | 9.5 |
| 13 | 1230 | 2.4 | 87 | 9.6 |
| 14 | 1230 | 2.1 | 83 | 9.9 |
| 15 | 1010 | 4.8 | 112 | 9.8 |
| 16 | 120 | 1.9 | 46 | 9.9 |

As indicated by Table 3, for each of the Samples, a high logarithmic log (Ω·cm) of insulation resistance that was equal to or more than 9.5 was obtained. d₃₃ of the Samples 7 and 8 could not be measured at a room temperature, as the Samples included large amount of Ta. In addition, it was confirmed that relative permittivity ES of both of the Samples 7 and 8 were 620 and 890, respectively, which were too low even to be utilized as a laminated capacitor.

It was confirmed that the Sample 9 could not exhibit a piezoelectric activity even after polarization and also was paraelectric at a room temperature; therefore it was not suitable for a piezoelectric ceramic electronic component. On the other hand, relative permittivity ∈s of the Sample 9 was as large as 1560, and therefore was useful for a dielectric ceramic electronic component such as ceramics capacitors.

It was confirmed that logarithmic log (Ω·cm) of insulation resistance of the Samples 10 and 11 were 10.6 and 10.1, respectively, and that the Samples 10 and 11 each had a high insulation resistance. In addition, it was also confirmed that d₃₃ of the Samples 10 and 11 were 83 pC/N and 91 pC/N, respectively, and that the Samples 10 and 11 each had a high d₃₃. As such, the Samples 10 and 11 each had good characteristics as a piezoelectric ceramic electronic component.

As indicated by Table 3, each of the Samples 12 through and 15 had a high insulation resistance equal to or more than 9.0. In addition, each of the Samples 12 through 15 had a high relative permittivity ES equal to or more than 1,000, and therefore could be used as a dielectric ceramic electronic components, such as ceramic capacitor.

The Sample 16 included Na_{0.5}K_{0.5}Nb_{0.5}O₃ composition that satisfied equations of x=1.0 and y=1.0 (i.e., NaNbO₃) as a main ingredient. NaNbO₃ itself was anti-ferroelectric and did not exhibit piezoelectric activity, but by adding an LiF, as indicated by Table 3, its d₃₃ changed to 46 pC/N and came to exhibit piezoelectric activity. The piezoelectric activity is considered to have been acquired in a process of Li dissolving to NaNbO₃. In addition, as indicated by Table 3, relative permittivity ∈s of the Sample 16 was 120; therefore, piezoelectric output constant in the direction of 33 (g33) was calculated as 43.3×10⁻³ (V/m). As such, the Sample 16 has a high output constant, and therefore was suitable for a piezoelectric ceramic electronic component.

### LIST OF REFERENCE NUMBERS

101: piezoelectric ceramic layer
102: inner electrode
103: outer electrode

What is claimed is:

1. A ceramic composition comprising: (NaₓK₁₋ₓ)(Nb_{y}Ta_{1-y})O₃ (0≦x≦1.0, 0.3<y≦1.0) as main ingredient; and Li and F in an amount ranging from 0.1 to 10.0 mol, calculated on lithium fluoride basis, relative to 100 mol of the main ingredient.

2. A laminated ceramic electronic component comprising:
a laminated body comprising:
at least one ceramic layer comprising the ceramic composition of claim 1; and
a pair of internal electrode layers provided on both primary surfaces of the ceramic layer: and
an external electrode disposed on a surface of the laminated body and connected to the pair of internal electrodes,
wherein the pair of internal electrodes comprises a base metal.

3. The laminated ceramic electronic component of claim 2, wherein the pair of internal electrodes include at least either one of Ni or Cu.

4. The laminated ceramic electronic component of claim 2, wherein the external electrode includes at least one metal selected from the group consisting of Ag, Ni and Cu.

5. A method of manufacturing a ceramic composition comprising a compound represented by (NaₓK₁₋ₓ)(Nb_{y}Ta_{1-y})O₃ (0≦x≦1.0, 0.3<y≦1.0) as main ingredient, the method comprising:
mixing a plurality of compounds selected from Na compounds, K compounds, Nb compounds, and Ta compounds to prepare a mixed material of the main ingredient,
pre-sintering the mixed material to obtain a pre-sintered composition;
disintegrating the pre-sintered composition to obtain pre-sintered powders;
mixing the disintegrated pre-sintered composition and LiF powder at a ratio of 1.0:0.1 to 1.0:0.001 to prepare a ceramic mixture;
firing the ceramic mixture in a reductive atmosphere with an oxygen partial pressure of 1.0×10⁻⁴-1.0×10⁻¹⁴ atm. at a temperature of 850-1400° C.
